(19) United States
(12) Patent Application Publication
(10) Pub. No.: US 2002/0119689 A1
(43) Pub. Date: Aug. 29, 2002

(54) Electrical test adapter

(75) Inventor: Andrew Philip Bennett, London (GB)

Correspondence Address: LAHIVE & COCKFIELD, 28 STATE STREET, BOSTON, MA, 02109, US

(73) Assignee: CHANNELL LIMITED, Orpington (GB)

(21) Appl. No.: 10/066,887

(22) Filed: Feb. 4, 2002

(30) Foreign Application Priority Data
Feb. 23, 2001 (GB) 0104498.1

(51) Int. Cl. H01R 13/15

(52) U.S. Cl. 439/259

(57) ABSTRACT

An electrical test adaptor comprises a pair of spaced apart elongate conductive probes supported on an insulating base, and a moveable deflector part comprising at least one cam surface adapted to bear on at least one of the probes when the deflector is in a closed position, thereby to deflect the probe from a non-contact position into a contact position. The contact position can be one in which the conductive probes are closer than in the non-contact position, and the deflector ideally has a pair of cam surfaces, each adapted to bear on one of the conductive probes. Further, an electrical test adaptor comprises a pair of elongate conductive probes supported on an insulating base, and a moveable locking part adapted to move between (i) an open position and (ii) a closed position in which the locking part is closer to the conductive probes than in the open position, the locking part having a retention surface facing the base. The retention surface can be a side of an aperture formed in the locking part. The base and the locking part/deflector can be hingedly attached, having gripping surfaces on outer faces thereof such that compression of the respective gripping surfaces causes the parts to rotate relative to each other by way of the hinge.

### FIELD OF THE INVENTION

The present invention relates to an electrical test adaptor.

### BACKGROUND ART

Test adaptors are required in order to establish a temporary electrical connection with a circuit in order to check the correct operation thereof. In telecommunications circuits, connection is made to discover whether the circuit is in use prior to work being carried out, and to test the continuity of a line to elsewhere.

The circuit to be tested is often concealed within a casing or shell, meaning that the test probe must be inserted into the casing in order to make contact. This establishes a conflict in the design of the circuit, since easy access for test purposes can (if care is not taken) allow access for damaging environmental influences. One way of overcoming this conflict is shown in our U.S. Pat. No. 5,399,100.

### SUMMARY OF THE INVENTION

The present invention therefore provides, in a first aspect, an electrical test adaptor comprising a pair of spaced apart elongate conductive probes supported on an insulating base, and a moveable deflector part comprising at least one cam surface adapted to bear on at least one of the probes when the deflector is in a closed position, thereby to deflect the probe from a non-contact position into a contact position.

It is preferred that the contact position is one in which the conductive probes are closer than in the non-contact position. This then allows the probes to be inserted, and the cam or cams applied to compress the probes onto electrical conductors within the device to be tested. Thus, the test access ports need not lead directly to the conductors, and a secure electrical contact can be made. It is further preferred that the deflector has a pair of cam surfaces, each adapted to bear on one of the conductive probes, as this offers the greatest security of contact.

The present invention also addresses the long term reliability of the test adaptor and the equipment it tests. Engineers operating in the field are prone to pull on the wires leading from the test adaptor in order to remove the test equipment. In the long term, this stresses the wires and the conductors, and can also affect the equipment being tested as the adaptor is removed suddenly and at a random angle.

In a second aspect, the present invention therefore provides an electrical test adaptor comprising a pair of elongate conductive probes supported on an insulating base, and a moveable locking part adapted to move between (i) an open position and (ii) a closed position in which the locking part is closer to the conductive probes than in the open position, the locking part having a retention surface facing the base. In this way, when the test adaptor is in place, the retention surface can locate behind a protrusion on the device to be tested. As the retention surface faces the base, an attempt to withdraw the test adaptor will be prevented whilst the adaptor is in the closed position.

The retention surface can be a side of an aperture formed in the locking part, in which case the aperture comes to rest over the protrusion as the adaptor closes.

It is also preferred that the conductive probes have an exposed part for attaching a test clip, such as an end of the conductive probe. Thus, electrical contact can be made via the attachment of a standard test clip such as a crocodile clip to the exposed part. If the wires are pulled sharply then the clips will disengage from the probes. No damage can be caused to the test equipment since the adaptor will remain in place for separate removal. If the wires and test clips are damaged then they can be replaced cheaply since they are a standard item.

A preferred arrangement is one in which the base and the locking part/deflector are hingedly attached. The locking part and the deflector can if desired be embodied in the same item. In this case, the two parts can each have gripping surfaces on outer faces thereof such that compression of the respective gripping surfaces causes the parts to rotate relative to each other by way of the hinge. This provides a simple and intuitive mode of operation.

### BRIEF DESCRIPTION OF THE DRAWINGS

An embodiment of the present invention will now be described by way of example, with reference to the accompanying figures, in which;

FIG. 1 is a perspective view of the device from above and to one side;

FIG. 2 is a perspective view of the device in place;

FIG. 3 is a perspective view of the device in place, with a test clip attached to one conductive probe;

FIG. 4 is a perspective view of the arrangement of FIG. 3, but from beneath; and

FIG. 5 is a perspective view of the locking part/deflector part.

### DETAILED DESCRIPTION OF THE EMBODIMENT

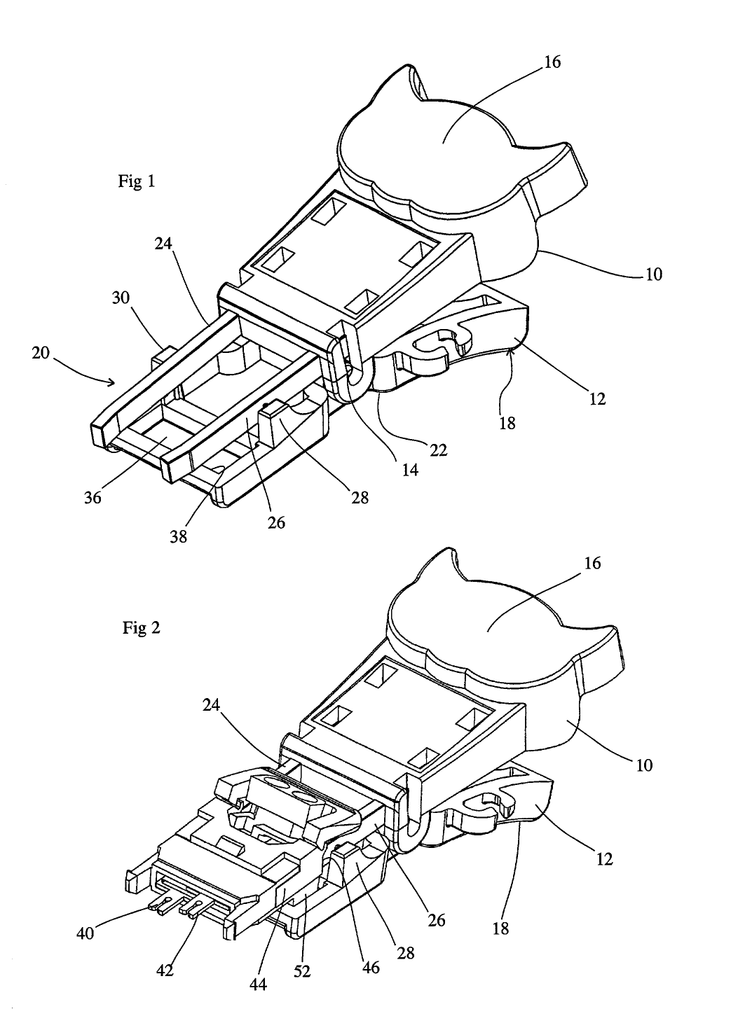

Referring to FIG. 1, the test adaptor comprises a body portion 10 and a deflector portion 12 attached at a hinge 14. A gripping surface 16 on one side of the body portion is matched by a corresponding gripping surface 18 on the deflector part. The two are hinged together at a bend 22 in the deflector part such that compressive pressure on the two surfaces 14, 16 causes the gripping end of the two parts to be brought closer together whilst the operative end 20 of the device opens.

A pair of conductive test probes 24, 26 are provided longitudinally within the body portion 10 in a generally aligned but spaced apart relationship. At one end thereof they are accessible beneath the gripping portion 16 of the body portion 10 (not visible in FIG. 1). At their other end, they extend past the hinge 14 and protrude from the body portion 10 which is cut short just after the hinge 14. Thus, the operative portion 20 consists of the test probes 24, 26 and the deflector portion 12.

The deflector portion has a pair of cam elements 28, 30 which extend transversely therefrom and, in the closed state of the device shown in FIG. 1, rest on the outer faces of the two test probes 24, 26 at a point midway along their exposed length. The inner surfaces 32, 34 of the cam elements 28, 30 can be seen in FIG. 5 and have a sloping aspect such that the gap therebetween is less at the base of the cam elements 28,30 than at the tip thereof. At its widest, the gap corresponds to the rest spacing of the outer faces of the test probes 24, 26. Thus, as the device closes the cam elements contact the outer faces of the test probes 24, 26 and the inner surfaces thereof force the test probes to close together.

An aperture 36 is formed in the deflector portion 12 adjacent the test probes 24, 26. This therefore defines a retention surface 38 facing the body portion 10, the purpose of which will be described below.

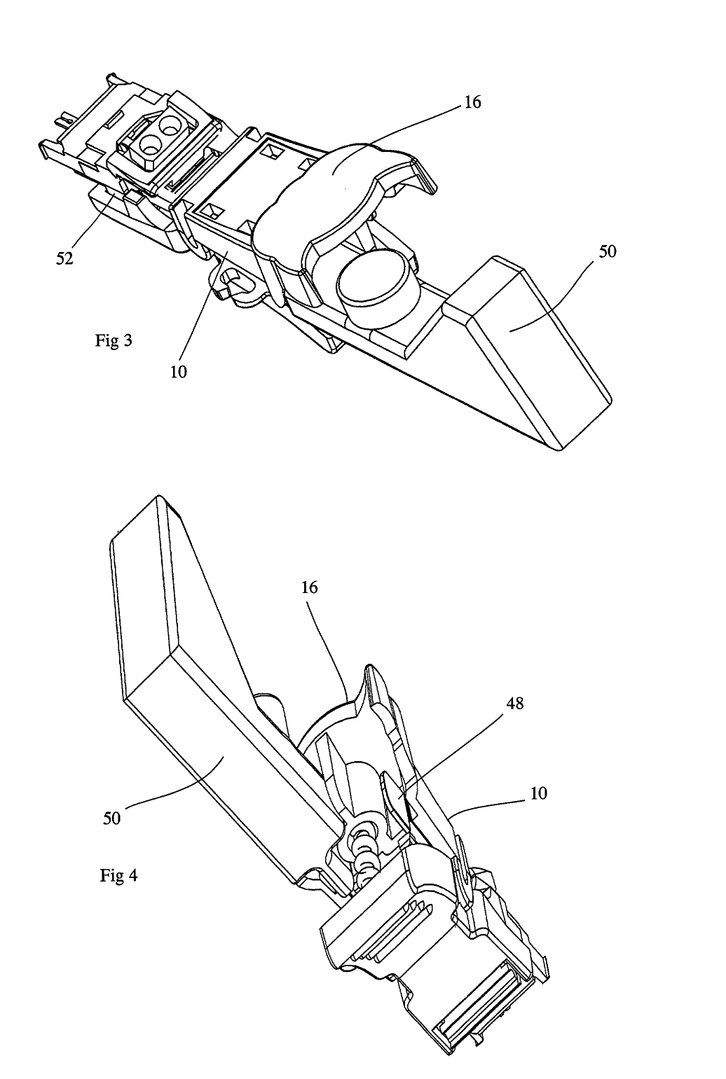

FIG. 2 shows the device attached to a MlNIROCKER™ connector produced by the applicants and described in another context in our earlier application GB 2293699. This has a pair of conductors 40, 42 lying mainly within the casing 44 but accessible via apertures 46 on the top surface of the casing 44. A straight path from the apertures 46 leads to a position alongside the conductors 40, 42. Thus, to make test contact the gripping portions 16, 18 are compressed, opening the test adaptor and releasing the test probes 24, 26 from the cam elements 28, 30 and allowing them to open out to their rest position. In this position they are spaced to fit into the apertures 46 of the connector and are inserted to lie alongside the conductors 40, 42. The pressure on the gripping portions 12, 16 is then released and the cam elements 28, 30 close on the test probes 24, 26 pressing them together. The test probes are thus closed onto the conductors 40, 42 within the casing 44 and make contact.

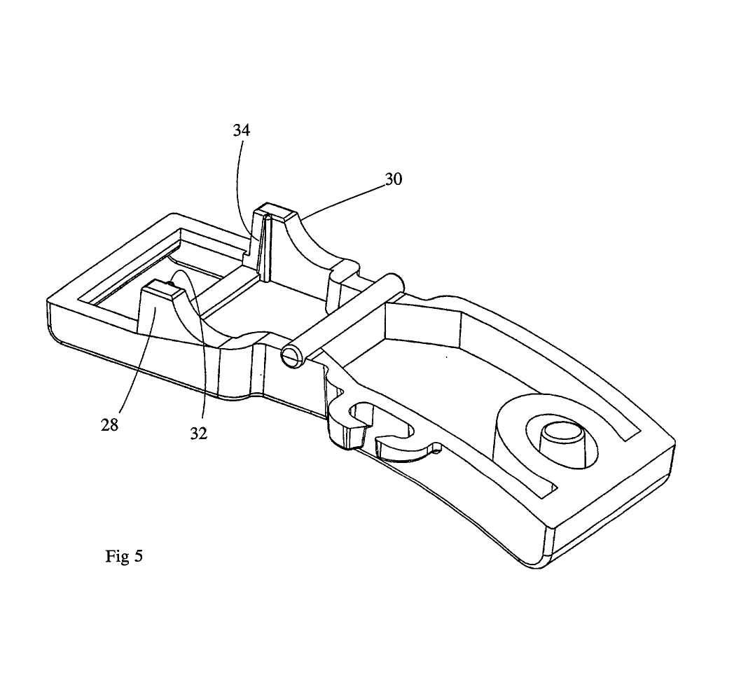

FIGS. 3 and 4 also show the device in place on a connector. From these angles the tip 48 of the test probe 24, 26 can be seen beneath the gripping portion 16 of the body part 10. A standard test clip 50 is shown attached to one probe 26; in practice a test clip would be attached to both probes.

It can be seen in FIGS. 2 and 3 that the connector casing 44 has a protrusion 52. When the test adaptor is open, the deflector portion 12 is sufficiently spaced from the test probes 24, 26 to clear this. However, when the adaptor closes to the state shown in FIGS. 2 and 3, the protrusion 52 projects into the aperture 36 mentioned above. Thus, if a user seeks to remove the adaptor from the connector without compressing the gripping portions 16, 18 to release the test probes 24, 26 from the conductors 40, 42, the retention surface 38 defined by the aperture 36 will bear against the protrusion 52 and prevent removal.

If wires attached to the test clips 50 are pulled, then the test clips 50 will be pulled from the test probes 24, 26 leaving the test adaptor in place on the connector and preventing damage thereto.

The main parts of the test adaptor can be made of any suitable engineering plastics material. The test probes are ideally of a spring steel or phosphor bronze.

It will be appreciated that many variations may be made to the above-described embodiments without departing from the scope of the present invention.

1. An electrical test adaptor, comprising a pair of spaced apart elongate conductive probes, an insulating base on which the probes are supported, and a moveable deflector part, wherein:
the base and the deflector are hingedly attached; and
the deflector part comprises at least one cam surface adapted to bear on at least one of the probes when the deflector is in a closed position, thereby to deflect the probe from a non-contact position into a contact position.

2. An electrical test adaptor according to claim 1, in which the contact position is one in which the conductive probes are closer to each other than in the non-contact position.

3. An electrical test adaptor according to claim 1 in which the deflector has a pair of cam surfaces, each adapted to bear on one of the conductive probes.

4. An electrical test adaptor according to claim 1 in which the base and the deflector each have gripping surfaces on outer faces thereof such that compression of the respective gripping surfaces causes the parts to rotate relative to each other by way of the hinge.

5. An electrical test adaptor according to claim 1, in which the deflector has a retention surface facing the base.

6. An electrical test adaptor according to claim 1 in which the conductive probes have an exposed part for attaching a test clip.

7. An electrical test adaptor comprising a pair of elongate conductive probes, an insulating base on which the probes are supported, and a moveable locking part,
the base and the locking part being hingedly attached;
the locking part:
(a) being adapted to move between (i) an open position and (ii) a closed position in which the locking part is closer to the conductive probes than in the open position, and
(b) having a retention surface facing the base.

8. An electrical test adaptor according to claim 7 in which the retention surface is a side of an aperture formed in the locking part.

9. An electrical test adaptor according to claim 7 in which the base and the locking part each have gripping surfaces on outer faces thereof such that compression of the respective gripping surfaces causes the parts to rotate relative to each other by way of the hinge.

10. An electrical test adaptor according to claim 7 in which the conductive probes have an exposed part for attaching a test clip.

11. An electrical test adaptor according to claim 10 in which the exposed part is an end of the conductive probe.

12. An electrical test adaptor, comprising a pair of elongate conductive probes, an insulating base on which the probes are supported, and a moveable deflector part, wherein:
the conductive probes are disposed in a generally aligned and spaced apart relationship;
the deflector part is arranged to move transversely to the probes and comprises at least one cam surface adapted to bear on at least one of the probes when the deflector is in a closed position, thereby to deflect the probe from a non-contact position into a contact position.

13. An electrical test adaptor according to claim 12, in which the contact position is one in which the conductive probes are closer to each other than in the non-contact position.

14. An electrical test adaptor according to claim 12 in which the deflector has a pair of cam surfaces, each adapted to bear on one of the conductive probes.

15. An electrical test adaptor according to claim 12 in which the base and the deflector are hingedly attached.

16. An electrical test adaptor according to claim 15 in which the base and the deflector each have gripping surfaces on outer faces thereof such that compression of the respective gripping surfaces causes the parts to rotate relative to each other by way of the hinge.

17. An electrical test adaptor according to claim 12, in which the deflector has a retention surface facing the base.

18. An electrical test adaptor according to claim 12 in which the conductive probes have an exposed part for attaching a test clip.
